(19) United States
(12) Patent Application Publication
(10) Pub. No.: US 2026/0317099 A1
(43) Pub. Date: Oct. 15, 2026

(54) CONVEYANCE EQUIPMENT

(71) Applicant: KOMATSU NTC LTD., Toyama (JP)

(72) Inventors: Masakazu SAKAI, Toyama (JP); Takashi YOTSU, Toyama (JP); Yuji KANEHIRA, Toyama (JP)

(73) Assignee: KOMATSU NTC LTD., Toyama (JP)

(21) Appl. No.: 19/465,102

(22) Filed: Jan. 30, 2026

(30) Foreign Application Priority Data
Feb. 4, 2025 (JP) 2025016716

(51) Int. Cl. B65H 5/02

(52) U.S. Cl. CPC B65H 5/023; B65H 5/025; B65H 2301/5115; B65H 2404/261; B65H 2404/264; B65H 2513/10; B65H 2701/19

(57) ABSTRACT

Conveyance equipment for conveying a sheet material from an upstream side to a downstream side includes: a first belt conveyor including a first conveyance belt; a second belt conveyor including a second conveyance belt and disposed downstream of the first belt conveyor; a first roller including a first rotation shaft and disposed at a downstream end of the first belt conveyor, the fist roller over which the first conveyance belt is placed; a second roller including a second rotation shaft and disposed at an upstream end of the second belt conveyor, the second roller over which the second conveyance belt is placed. The first rotation shaft and the second rotation shaft are set on the identical axis.

### CROSS REFERENCE TO RELATED APPLICATION

The entire disclosure of Japanese Patent Application No. 2025-016716, filed on Feb. 4, 2025, is incorporated herein by reference in its entirety.

### BACKGROUND

The present disclosure relates to conveyance equipment for a sheet material.

Conventionally, there is known conveyance equipment that conveys paper sheets (sheet materials) such as banknotes and securities from an upstream side to a downstream side (for example, see Japanese Patent Application Publication No. 2014-172672). Specifically, the conveyance equipment includes two sets of conveyors each including a drive pulley, a driven pulley disposed at a predetermined interval from the drive pulley, and an annular conveyance belt placed over the drive pulley and the driven pulley. These are arranged so as to be aligned from the upstream side to the downstream side. According to the conveyance equipment, the paper sheet conveyed by the upstream conveyor is delivered from the rear end of the upstream conveyor to the front end of the downstream conveyor. Thereafter, the paper sheet is further conveyed toward the rear end of the downstream conveyor by the downstream conveyor.

### SUMMARY

However, when the object to be conveyed is a flexible metal foil (sheet material) or the like, the conveyance equipment needs to prevent the object to be conveyed from being caught in a joint between the upstream conveyor and the downstream conveyor without being delivered from the upstream conveyor to the downstream conveyor.

The present disclosure is directed to conveyance equipment which conveys a sheet material from an upstream side to a downstream side more reliably without the sheet material being caught in a joint of a conveyor.

Conveyance equipment of the present disclosure for conveying a sheet material from an upstream side to a downstream side includes: a first belt conveyor including a first conveyance belt; a second belt conveyor including a second conveyance belt and disposed downstream of the first belt conveyor; a first roller including a first rotation shaft and disposed at a downstream end of the first belt conveyor, the fist roller over which the first conveyance belt is placed; a second roller including a second rotation shaft and disposed at an upstream end of the second belt conveyor, the second roller over which the second conveyance belt is placed. The first rotation shaft and the second rotation shaft are set on the identical axis.

According to the conveyance equipment of the present disclosure, the sheet material can be more reliably conveyed from the upstream side to the downstream side without being caught in the joint of the conveyor.

### BRIEF DESCRIPTION OF THE ACCOMPANYING DRAWINGS

FIG. 1 is a configuration explanatory diagram of a cutting apparatus for a sheet material including conveyance equipment according to an embodiment of the present disclosure.

FIG. 2 is a cross-sectional view of a sheet material conveyed by the conveyance equipment according to the embodiment of the present disclosure.

FIG. 3 is a perspective view of conveyance equipment according to an embodiment of the present disclosure.

### DESCRIPTION OF EMBODIMENTS

A mode (embodiment) for carrying out conveyance equipment of the present disclosure will be described in detail with reference to the drawings as appropriate. Hereinafter, the present disclosure will be described in detail by taking conveyance equipment applied to a cutting apparatus for a sheet material as an example, but the present disclosure is not limited thereto. The present disclosure can be applied to various apparatuses that convey thin and flexible sheet materials.

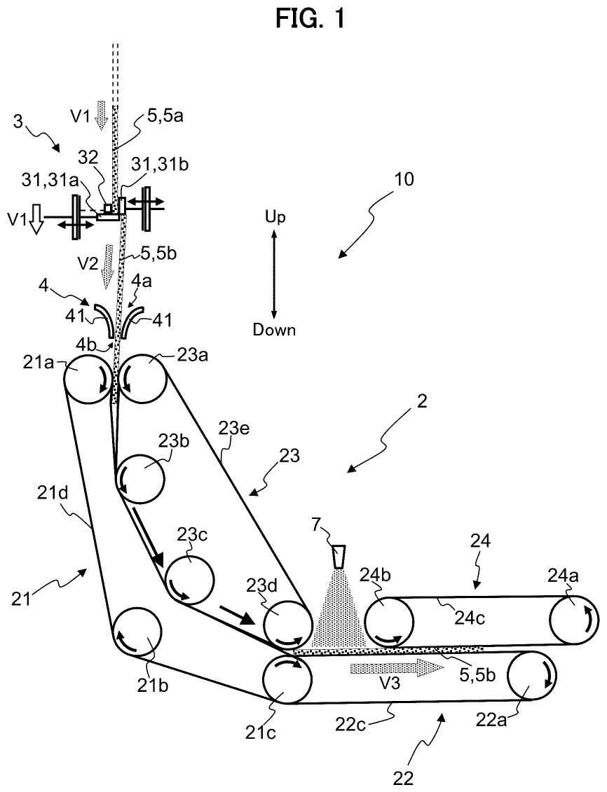

FIG. 1 is a configuration explanatory diagram of a cutting apparatus 10 for a sheet material 5 including conveyance equipment 2 according to the present embodiment. For convenience of drawing, FIG. 1 schematically illustrates the cutting apparatus 10, the conveyance equipment 2, and the sheet material 5. The dimensions, shapes and relative positions of the components of the cutting apparatus 10 and the conveyance equipment 2, and the dimensions and shapes of the sheet material 5 are different from the actual ones.

Hereinafter, the entire construction of the cutting apparatus 10 will be described, and then the conveyance equipment 2 according to the present embodiment will be described. The cutting apparatus 10 cuts a sheet material 5 into a predetermined length. The sheet material 5 is continuously conveyed from an upstream side set upward in a vertical direction to a downstream side set downward in the vertical direction by a predetermined conveyance mechanism. As shown in FIG. 1, the cutting apparatus 10 mainly includes a cutting mechanism 3, a guide mechanism 4, and conveyance equipment 2 from an upstream side to a downstream side in a direction in which the sheet material 5 is conveyed. The cutting apparatus 10 includes a feed unit (not shown) that is disposed further upstream of the cutting mechanism 3 and feeds the long sheet material 5a to the cutting mechanism 3.

The feed unit mainly includes a roll unit over which the long sheet material 5a is placed, and a feed mechanism including, for example, a pair of nip rollers. The feed mechanism feeds the sheet material 5a at a feed speed V1 while applying a predetermined tensile force to the sheet material 5a from the roll portion. In the following description, when the long sheet material 5a and a sheet material 5a of a sheet piece (described later) cut out from the sheet material 5b are not distinguished from each other, they are simply referred to as a sheet material 5.

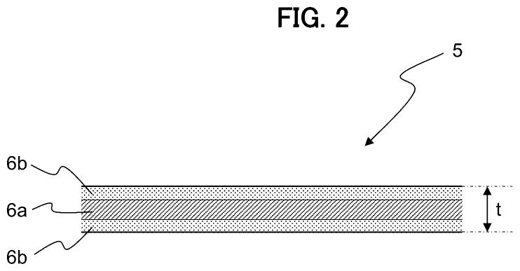

FIG. 2 is a cross-sectional view of the sheet material 5 to be cut by the cutting apparatus 10 (see FIG. 1). The sheet material 5 in the present embodiment is assumed to be a coated current collector foil which is an electrode material for a secondary battery. That is, the sheet material 5 is assumed to be a material in which an active material layer 6a containing a predetermined active material, a conductive agent, a binder, and the like selected according to the polarity is applied to both surfaces of a metallic film 6b such as a copper film or an aluminum film selected according to the polarity. The thickness t of the sheet material 5 is assumed to be 50 μm or more and 200 μm or less, for example, about 100 μm.

The sheet material 5 that can be cut by the cutting apparatus 10 is not limited to this as long as it is thin and flexible, and examples thereof include other thin sheets such as a resin film and a metal foil. However, the conveyance equipment 2 of the present embodiment applied to the cutting apparatus 10 does not exclude paper sheets as the sheet material 5.

Returning to FIG. 1, the cutting mechanism 3 includes a cutter 31 for the 5a of the sheet material and a gripper 32 for the 5a of the sheet material. The cutter 31 includes a cutting blade 31a which is a punch for shearing the sheet material 5a and a fixed blade 31b of a die.

The cutter 31 in the present embodiment constitutes a flying shear cutter. That is, the cutter 31 cuts the sheet material 5a into the sheet material 5b of a predetermined length while moving at a speed V1 to follow the sheet material 5a conveyed at the feed speed V1. The fixed blade 31b is positioned along the sheet material 5a when cutting the sheet material 5a. The cutting blade 31a shears the sheet material 5a by moving toward the fixed blade 31b. The fixed blade 31a and the cutting blade 31b after cutting the sheet material 5a are displaced so as to be separated apart from the sheet material 5a and move upward. As a result, the fixed blade 31b and the cutting blade 31a return to the initial positions before the following movement with respect to the sheet material 5a.

The gripper 32 is disposed upstream of the cutting blade 31a, as shown in FIG. 1. The gripper 32 in the present embodiment moves following the sheet material 5a at the speed V1 on the upstream side of the cutting blade 31a while the cutting blade 31a cuts the sheet material 5a. The gripper 32 holds the sheet material 5a by interposing it between the fixed blade 31b and the gripper 32 with a predetermined load. After the sheet material 5a is cut, gripper 32 is displaced away from the sheet material 5a and moves upward. As a result, the gripper 32 returns to the initial position before the gripper 32 moves to follow the sheet material 5a.

As shown in FIG. 1, the guide mechanism 4 is disposed downstream of the cutting mechanism 3. The guide mechanism 4 has a pair of wall parts 41 whose interval is gradually narrowed from the inlet 4a part of the sheet material 5 toward the outlet 4b part. The guide mechanism 4 guides the sheet material 5 conveyed from the cutting mechanism 3 to the conveyance equipment 2 according to the present embodiment described next.

As shown in FIG. 1, the conveyance equipment 2 includes a first belt conveyor 21, a second belt conveyor 22, a third belt conveyor 23, and a fourth belt conveyor 24. The conveyance equipment 2 includes a dust removal mechanism 7.

The first belt conveyor 21 includes three rollers of a first guide roller 21a, a second guide roller 21b, and a drive roller 21c from the upstream side to the downstream side. The first belt conveyor 21 includes an annular conveyance belt 21d which extends between the rollers 21a, 21b, and 21c. The drive roller 21c disposed at the downstream end of the first belt conveyor 21 corresponds to a “first roller”.

Among the three rollers including the first guide roller 21a, the second guide roller 21b, and the drive roller 21c, the second guide roller 21b located at the center in the vertical direction is displaced in a direction away from the third belt conveyor 23. Thus, the conveyance belt 21d extends between the rollers 21a, 21b, and 21c so as to form a substantially triangular shape having the first guide roller 21c, the second guide roller 21a, and the drive roller 21c as vertices. The first belt conveyor 21 cooperates with a third belt conveyor 23 described later to change the conveyance direction of the cut sheet material 5b, which is fed from above to below in the vertical direction, to a substantially horizontal direction.

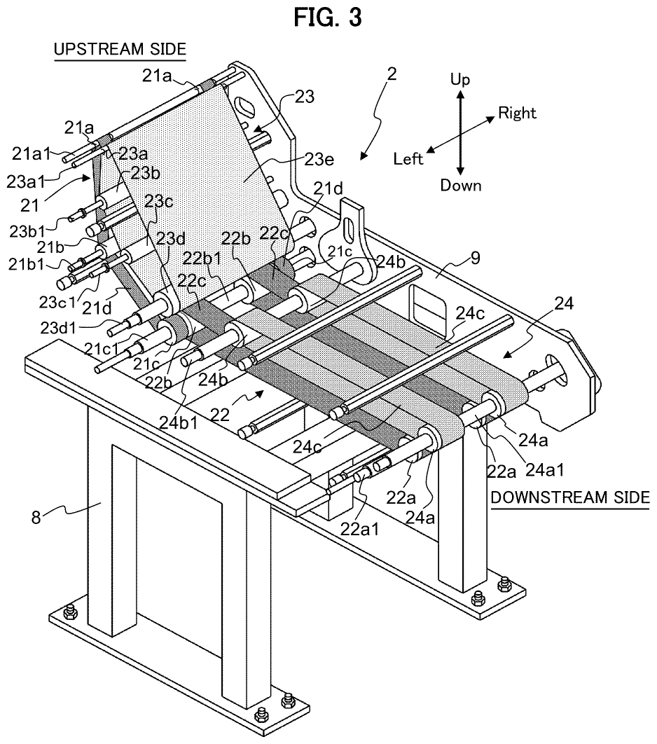

The second belt conveyor 22 is disposed so as to extend in a substantially horizontal direction on the downstream side of the first belt conveyor 21. The second belt conveyor 22 includes two rollers of a drive roller 22a disposed at a downstream end and a guide roller 22b (see FIG. 3) described later disposed at an upstream end. The second belt conveyor 22 has an annular conveyor belt 22c that extends between the roller 22a and the roller 22b. The guide roller 22b (see FIG. 3) disposed at the upstream end of the second belt conveyor 22 corresponds to a “second roller”. The relationship between the guide roller 22b (see FIG. 3) as the “second roller” and the drive roller 21c as the “first roller” will be described in detail later.

The third belt conveyor 23 includes four rollers of a first guide roller 23a, a second guide roller 23b, a third guide roller 23c, and a drive roller 23d from the upstream side to the downstream side. The third belt conveyor 23 includes an annular conveyor belt 23e extending between the rollers 23a, 23b, 23c, and 23d. The first guide roller 23a of the third belt conveyor 23 and the first guide roller 21a of the first belt conveyor 21 are disposed at substantially the same height in the vertical direction.

Among the four rollers including the first guide roller 23a, the second guide roller 23b, the third guide roller 23c, and the drive roller 23d, the second guide roller 23b and the third guide roller 23c located at the center in the vertical direction are arranged side by side between the first guide roller 21a and the drive roller 21c of the first belt conveyor 21. Accordingly, the conveyance belt 23e extends between the first guide roller 23a, the second guide roller 23b, the third guide roller 23c, and the drive roller 23d so as to form an isosceles trapezoid having the respective rollers as vertices.

The second guide roller 23b and the third guide roller 23c of the third belt conveyor 23 are disposed between the first guide roller 21a and the drive roller 21c of the first belt conveyor 21. Accordingly, the conveyance belt 21d and the conveyor belt 23e are in contact with each other between the first belt conveyor 21 and the third belt conveyor 23.

The first guide roller 21a and the first guide roller 23a are rotated in opposite directions to each other, and the conveyance belt 21d and the conveyance belt 23e are moved downward between the first belt conveyor 21 and the third belt conveyor 23. To be specific, in the example illustrated in FIG. 1, the first guide roller 21a rotates clockwise, and the first guide roller 23a rotates counterclockwise at the same rotation speed as the first guide roller 21a. The cut sheet material 5b is conveyed downstream at the speed V2 while being held between the first belt conveyor 21 and the third belt conveyor 23. The sheet material 5b is conveyed at the feed speed V2 by the first belt conveyor 21 and the third belt conveyor 23. The feed speed V2 of the sheet material 5b is set to a speed that is about 1% higher than the feed speed V1 of the long sheet material 5a, but is not limited thereto.

The fourth belt conveyor 24 is disposed above the second belt conveyor 22 so as to extend along the second belt conveyor 22. The fourth belt conveyor 24 includes two rollers of a drive roller 24a disposed at a downstream end and a guide roller 24b disposed at an upstream end. The fourth belt conveyor 24 has an annular conveyor belt 24c that extends between these rollers 24a, 24b. In FIG. 1, the 24c of the conveyor belt is shown as being apart from the conveyor belt 22c of the second belt conveyor 22, but the conveyor belt 24c and the conveyor belt 22c are actually in contact with each other.

The fourth belt conveyor 24 is disposed downstream of the third belt conveyor 23 with a predetermined space interval from the third belt conveyor 23. Accordingly, the upper surface of the conveyed sheet material 5b faces a space between the drive roller 23d at the downstream end of the third belt conveyor 23 and the guide roller 24b of the fourth belt conveyor 24.

The drive roller 22a of the second belt conveyor 22 and the drive roller 24a of the fourth belt conveyor 24 rotate in opposite directions to each other, and move the conveyance belt 22c and the conveyance belt 24c toward the downstream side between the fourth belt conveyor 24 and the second belt conveyor 22. In the example shown in FIG. 1, the drive roller 22a rotates clockwise, and the drive roller 24a rotates counterclockwise at the same rotation speed as the drive roller 22a.

Thus, the sheet material 5b is conveyed toward the downstream side at the speed V3 while being held between the second belt conveyor 22 and the fourth belt conveyor 24. The sheet material 5b is conveyed at the feed speed V3 by the second belt conveyor 22 and the fourth belt conveyor 24. The feed speed V3 of the sheet material 5b is set to a speed that is about 1% higher than the feed speed V2 of the sheet material 5b conveyed by the first belt conveyor 21 and the third belt conveyor 23. In particular, the feed speed V3 is set to about 500 to 600 mm/sec, but is not limited thereto.

Next, the dust removal mechanism 7 (see FIG. 1) will be described. The dust removal mechanism 7 in the present embodiment is assumed to be a blowing device such as a blower. The blower removes dust such as chips, which may be generated when the cutter 31 (see FIG. 1) cuts the sheet material 5a (see FIG. 1), from the sheet material 5b (see FIG. 1). As shown in FIG. 1, the dust removal mechanism 7 is disposed above the second belt conveyor 22. To be more specific, the dust removal mechanism 7 blows air to the upper surface of the sheet material 5b facing upward between the drive roller 23d of the third belt conveyor 23 and the guide roller 24b of the fourth belt conveyor 24. The dust removal mechanism 7 also serves as a mechanism for preventing the sheet material 5b conveyed between the drive roller 23d and the guide roller 24b from floating.

Next, the conveyance equipment 2 according to the present embodiment will be described in more detail with reference to FIG. 3. In the following description, the up, down, left, and right directions are based on the up and down in the vertical direction, and are based on the left and right when the conveyance equipment 2 is viewed from the downstream side to the upstream side. FIG. 3 is a perspective view of the conveyance equipment 2, and illustrates a state in which the conveyance equipment 2 is viewed from obliquely above on the downstream side of the conveyance equipment 2. In FIG. 3, the dust removal mechanism 7 (see FIG. 1) and one of a pair of support plates 9 described later are omitted for convenience of drawing.

As shown in FIG. 3, the conveyance equipment 2 includes a support base 8 and a pair of support plates 9 (only one of which is shown in FIG. 3) that are provided upright along both left and right sides of an upper portion of the support base 8. The pair of support plates 9 are disposed between the first belt conveyor 21, the second belt conveyor 22, the third belt conveyor 23, and the fourth belt conveyor 24, and support them.

The first belt conveyor 21 has a pair of (plural rows of) conveyor belts 21d. The distance between the pair of conveyor belts 21d can be adjusted in accordance with the width of the sheet material 5 (see FIG. 1) to be conveyed. The distance between the pair of conveyor belts 21d is set such that, for example, the space interval between the outer edges of the conveyor belts 21d in the left-right direction is slightly smaller than the width of the sheet material 5 (see FIG. 1). On the other hand, the space interval may be set as appropriate within a range in which the sheet material 5 (see FIG. 1) can be conveyed.

The first belt conveyor 21 includes a pair of first guide rollers 21d, a pair of second guide rollers 21a (one of the second guide rollers 21b is not shown in FIG. 3), and a pair of drive rollers 21c so as to correspond to the pair of conveyance belts 21d. The first guide rollers 21a are rotatably attached to the rotation shaft 21a1 via bearings (not shown). The rotation shaft 21a1 is supported by a support plate 9.

The second guide rollers 21b are rotatably attached to the rotation shaft 21b1 via bearings (not shown). The rotation shaft 21b1 is supported by a support plate 9. The drive roller 21c are attached to the rotation shaft 21c1. The rotation shaft 21c1 is supported by a support plate 9. The drive rollers 21c are rotated at the predetermined speed by a motor with a reduction gear (not shown) connected to the rotation shaft 21c1.

The second belt conveyor 22 includes a pair of conveyor belts 22c. The pair of conveyor belts 22c are disposed immediately inside the pair of conveyor belts 21d of the first belt conveyor 21. The second belt conveyor 22 has a pair of guide rollers 22c (the second rollers) and a pair of drive rollers 22b so as to correspond to the pair of conveyance belts 22a. The guide rollers 22b (the second roller) are disposed immediately inside the drive rollers 21c (the first roller) of the first belt conveyor 21. The guide rollers 22b are rotatably attached to the rotation shaft 22b1 via bearings (not shown). The rotation shaft 22b1 is supported by a support plate 9.

The rotation axis 22b1 of the second belt conveyor 22 and the rotation axis 21c1 of the first belt conveyor 21 are disposed on the same axis. That is, the guide roller 22b (the second roller) of the second belt conveyor 22 and the drive roller 21c (the first roller) of the first belt conveyor 21 are rotatable independently of each other on the same axis. The drive roller 22a is supported by the support plate 9 via the rotation shaft 22a1. The drive roller 22a is rotated at the predetermined speed by a motor with a reduction gear (not shown) connected to the rotation shaft 22a1.

The third belt conveyor 23 includes a single and wide conveyor belt 23e. The width of the conveyor belt 23e in the present embodiment is preferably set to be slightly narrower than the width of the sheet material 5. On the other hand, the width may be set as appropriate within a range in which the sheet material 5 can be conveyed.

The first guide roller 23a is rotatably attached to the rotation shaft 23a1 via bearings (not shown). The rotation shaft 23a1 is supported by a support plate 9. The second guide roller 23b is rotatably attached to the rotation shaft 23b1 via bearings (not shown). The rotation shaft 23b1 is supported by a support plate 9. The third guide roller 23c is rotatably attached to the rotation shaft 23c1 via bearings (not shown). The rotation shaft 23c1 is supported by a support plate 9. The drive roller 23d is supported by the support plate 9 via the rotation shaft 23d1. The drive roller 23d is rotated at the predetermined speed by a motor with a reduction gear (not shown) connected to the rotation shaft 23d1.

The fourth belt conveyor 24 has a pair of conveyor belts 24c. As described above, the conveyor belts 24c are in contact with the conveyor belts 22c of the second belt conveyor 22 from above respectively. The fourth belt conveyor 24 includes a pair of guide rollers 24c and a pair of drive rollers 24b so as to correspond to the pair of conveyance belts 24a. The guide rollers 24b are rotatably attached to the rotation shaft 24b1 via bearings (not shown). The rotation shaft 24b1 is supported by a support plate 9. The drive rollers 24a are supported by the support plate 9 via the rotation shaft 24a1. The drive rollers 24a are rotated at the predetermined speed by a motor with a reduction gear (not shown) connected to the rotation shaft 24a1.

### <<Operation and Effect>>

Next, the operation and effect of the present embodiment will be described. The conveyance equipment 2 of the present embodiment conveys the sheet material 5b from the upstream side to the downstream side. The conveyance equipment 2 includes a first belt conveyor 21 and a second belt conveyor 22 disposed on the downstream side of the first belt conveyor 21. The conveyance belt 21d is placed over the rotation axis 21c1 of a drive roller 21c (first roller) at a downstream end of a first belt conveyor 21. The conveyance belt 22b1 is placed over the rotation axis 22b1 of a guide roller 22b (second roller) at an upstream end of a second belt conveyor 22. The rotation axis 21c1 and the rotation axis 22b1 are set on the same axis.

According to the conveyance equipment 2, there is no joint between the first belt conveyor 21 disposed on the upstream side and the second belt conveyor 22 disposed on the downstream side. Accordingly, the conveyance equipment 2 can more reliably convey the sheet material 5b from the upstream side to the downstream side without the sheet material being caught in the joint of the conveyors 21, 22.

In the conveyance equipment 2, the first belt conveyor 21 has a pair of (plural rows of) conveyance belts 21c in the direction of the rotation axis 21c1 of the drive roller 21d (first roller). The second belt conveyor 22 has at least one row (a pair (plural rows) in the present embodiment) of conveyor belt 22c positioned between the pair (the plural rows) of conveyor belts 22d of the first belt conveyor 21.

According to the conveyance equipment 2, the sheet material 5b conveyed by the first belt conveyor 21 can be more reliably delivered from the downstream end of the first belt conveyor 21 to the upstream end of the second belt conveyor 22.

In the conveyance equipment 2, the drive roller 21c (first roller) of the first belt conveyor 21 and the guide roller 22b (second roller) of the second belt conveyor 22 are rotatable independently of each other.

According to the conveyance equipment 2, the feed speed V2 of the sheet material 5b in the first belt conveyor 21 and the feed speed V3 of the sheet material 5b in the second belt conveyor 22 can be set independently of each other.

The conveyance equipment 2 further includes a third belt conveyor 23. The third belt conveyor 23 has at least one row (one row in the present embodiment) of conveyance belt 21e that conveys the sheet material 5b in cooperation with the conveyance belt 21d of the first belt conveyor 21 while holding the sheet material 5b between the conveyance belt 21e and the conveyance belt 21d.

According to the conveyance equipment 2, the first belt conveyor 21 can more stably convey the sheet material 5b to the downstream side in cooperation with the third belt conveyor 23.

The conveyance equipment 2 further includes a fourth belt conveyor 24. The fourth belt conveyor 24 has at least one row (a pair (plural rows) in the present embodiment) of conveyance belt 24c. The conveyance belt 24c conveys the sheet material 5b in cooperation with the conveyance belt 22c of the second bet conveyor 22 while holding the sheet material 5b between the conveyance belt 24c and the conveyance belt 22c.

According to the conveyance equipment 2, the second belt conveyor 22 can more stably convey the sheet material 5b to the downstream side in cooperation with the fourth belt conveyor 24.

In the conveyance equipment 2, the feed speed V3 of the sheet material 5b by the second belt conveyor 22 and the fourth belt conveyor 24 is set to be higher than the feed speed V2 of the sheet material 5b by the first belt conveyor 21 and the third belt conveyor 23.

According to the conveyance equipment 2, the second belt conveyor 22 and the fourth belt conveyor 24 quickly convey the sheet material 5b delivered from the first belt conveyor 21 and the third belt conveyor 23 to the downstream side. Thus, the sheet material 5b conveyed from the first belt conveyor 21 and the third belt conveyor 23 next is efficiently delivered to the second belt conveyor 22 and the fourth belt conveyor 24.

In the conveyance equipment 2, the third belt conveyor 23 and the fourth belt conveyor 24 are arranged with a predetermined space interval therebetween. The conveyance equipment 2 includes a dust removal mechanism 7 for removing dust adhering to the sheet material 5b which is conveyed while facing a space between the third belt conveyor 23 and the fourth belt conveyor 24.

According to the conveyance equipment 2, dust adhering to the sheet material 5b being conveyed is removed, and the sheet material 5b for a product is improved in quantity. The dust removal mechanism 7 is particularly effective when the dust (chips) is dust of the material (sheet material 5b) of the electrodes of the secondary batteries which affects the electrical properties.

Although the embodiment of the present disclosure has been described above, the present disclosure is not limited to the embodiment and can be implemented in various forms. In the above embodiment, the conveyance equipment 2 in which the third belt conveyor 23 has a single conveyance belt 23e has been described. On the other hand, in the conveyance equipment 2, the third belt conveyor 23 may have plural rows of conveyance belts 23e. That is, in the conveyance equipment 2, the second belt conveyor 22, the third belt conveyor 23, and the fourth belt conveyor 24 may respectively have plural rows of the conveyance belts 22c, the conveyance belts 23e, and the conveyance belts 24c.

According to the conveyance equipment 2, the conveyance belt 22c, the conveyance belt 23e, and the conveyance belt 24c are respectively arranged in plural rows, and thus the sheet material 5b can be more stably conveyed.

In the above embodiment, the conveyance equipment 2 including the third belt conveyor 23 and the fourth belt conveyor 24 has been described. On the other hand, the third belt conveyor 23 may be a roller conveyor (not shown) in which the conveyance belt 23e is omitted. The fourth belt conveyor 24 may be a roller conveyor (not shown) in which the conveyance belt 24c is omitted. That is, the conveyance equipment 2 may further include a roller conveyor (not shown). The roller conveyor (not shown) may include a roller portion (not shown) that conveys the sheet material 5b in cooperation with the conveyance belt 21d and/or the conveyance belt 22c while holding the sheet material 5b between the roller portion and at least one of the conveyance belt 21d of the first belt conveyor 21 and the conveyance belt 22c of the second belt conveyor 22.

According to the conveyance equipment 2, the conveyance belts 23e, 24c are omitted, and the construction of the conveyance equipment 2 is further simplified.

In the above embodiment, the conveyance equipment 2 in which the dust removal mechanism 7 is disposed above the second belt conveyor 22 has been described. On the other hand, the dust removal mechanism 7 may be disposed below the second belt conveyor 22. That is, in the conveyance equipment 2, although not shown, the second belt conveyor 22 may have plural rows of conveyance belts 22c, and the dust removal mechanism 7 may be provided to remove dust adhering to the sheet material 5b which is conveyed while facing a space between the plural rows of conveyance belts 22c on the opposite side of the fourth belt conveyor 24.

The conveyance equipment 2 removes dust adhering to the lower surface of the conveyed sheet material 5b.

What is claimed is:

1. Conveyance equipment for conveying a sheet material from an upstream side to a downstream side, the conveyance equipment comprising:
a first belt conveyor including a first conveyance belt;
a second belt conveyor including a second conveyance belt and disposed downstream of the first belt conveyor;
a first roller including a first rotation shaft and disposed at a downstream end of the first belt conveyor, the first roller over which the first conveyance belt is placed;
a second roller including a second rotation shaft and disposed at an upstream end of the second belt conveyor, the second roller over which the second conveyance belt is placed;
wherein the first rotation shaft and the second rotation shaft are set on the identical axis.

2. The conveyance equipment according to claim 1,
wherein the first belt conveyor includes plural rows of first conveyance belts in a direction of a rotation axis of the first roller, and
wherein the second belt conveyor includes at least one row of second conveyance belts located between the plural rows of the fist conveyance belts of the first belt conveyor.

3. The conveyance equipment according to claim 1,
wherein the first roller of the first belt conveyor and the second roller of the second belt conveyor are rotatable independently of each other.

4. The conveyance equipment according to claim 1, further comprising a third belt conveyor,
wherein the third belt conveyor includes at least one row of third conveyance belts which conveys the sheet material in cooperation with the first conveyance belt of the first belt conveyor while holding the sheet material between the first conveyance belt and the at least one row of the third conveyance belts.

5. The conveyance equipment according to claim 4, further comprising a fourth belt conveyor,
wherein the fourth belt conveyor includes at least one row of a fourth conveyance belt which conveys the sheet material in cooperation with the second conveyance belt of the second belt conveyor while holding the sheet material between the second conveyance belt and the at least one row of the fourth conveyance belt.

6. The conveyance equipment according to claim 5,
wherein the sheet material is conveyed by the second belt conveyor and the fourth belt conveyor at a first feed speed,
wherein the sheet material is conveyed by the first belt conveyor and the third belt conveyor at a second feed speed,
wherein the first feed speed is set to be higher than the second feed speed.

7. The conveyance equipment according to claim 5,
wherein the third belt conveyor and the fourth belt conveyor are disposed with a space interval therebetween,
wherein the conveyance equipment further comprising a dust removal mechanism configured to remove dust attached to the sheet material which is conveyed while facing a space between the third belt conveyor and the fourth belt conveyor.

8. The conveyance equipment according to claim 5, wherein the second belt conveyor, the third belt conveyor, and the fourth belt conveyor each include plural rows of conveyance belts.

9. The conveyance equipment according to claim 1, further comprising a roller conveyor,
wherein the roller conveyor includes a roller part between the roller conveyor and at least one of first conveyor belt of the first belt conveyor and the second conveyor belt of the second belt conveyor,
wherein the roller part conveys the sheet material in cooperation with at least one of the first conveyor belt and the second conveyor belt while holding the sheet material between the roller part and the at least one of the first conveyor belt and the second conveyor belt.

10. The conveyance equipment according to claim 5,
wherein the second belt conveyor includes plural rows of second conveyance belts,
the conveyance equipment further comprising a dust removal mechanism disposed on the opposite side of the fourth belt conveyor and configured to remove dust attached to the sheet material which is conveyed while facing a space between the plural rows of second conveyance belts.

11. The conveyance equipment according to claim 1,
wherein the sheet material is a coated current collector foil of an electrode material for a secondary battery.
